(19) United States
(12) Patent Application Publication
(10) Pub. No.: US 2005/0276608 A1
(43) Pub. Date: Dec. 15, 2005

(54) Establishment and maintenance of optical links between optical transceiver nodes in free-space optical communications networks

(76) Inventor: Andrew Pavelchek, Poway, CA (US)

Correspondence Address: B. Noel Kivlin;Meyertons, Hood, Kivlin, Kowert & Goetzel, P.C., P.O. Box 398, Austin, TX, 78767-0398, US

(21) Appl. No.: 11/131,746

(22) Filed: May 17, 2005

Related U.S. Application Data
(63) Continuation of application No. 09/955,520, filed on Sep. 12, 2001, now abandoned.
(60) Provisional application No. 60/241,315, filed on Oct. 16, 2000.
(60) Provisional application No. 60/241,419, filed on Oct. 17, 2000.

(51) Int. Cl. H04B 10/00

(52) U.S. Cl. 398/135

(57) ABSTRACT

A system and method for establishing and maintaining optical links between optical transceiver nodes in a free space optical communications network is disclosed. The system and method provide a protocol for acquisition of an optical link between transceivers in two adjacent nodes and for re-acquisition should a node be replaced or moved. The system and method also provide a protocol for tracking small movements of one or both nodes in a link. Also, the system and method provide a protocol for recovering a link that is temporarily lost.

### CROSS-REFERENCE TO RELATED APPLICATIONS

This application claims the benefit of U.S. Provisional Application Ser. No. ______ filed Oct. 16, 2000, titled Establishment and Maintenance of Optical Links Between Optical Transceiver Nodes in Free-Space Optical Communication Networks and U.S. Provisional Application Ser. No. ______ filed Oct. 17, 2000, titled Control Method for Free-Space Optical Communication System.

### BACKGROUND OF THE INVENTION

1. Field of the Invention

The present invention relates generally to communication systems, and more particularly to a system and method for establishing and maintaining optical links between optical transceiver nodes in free-space optical communications networks.

2. Description of the Related Art

Over the last several years there has been tremendous growth in the deployment of fiber-optic facilities by telecommunications carriers such as Regional Bell Operating Companies (RBOCs), cable carriers, and Competitive Local Exchange Carriers (CLECs). Deployment of these facilities along with the introduction of technologies such as OC-192 and DWDM has dramatically lowered the marginal cost of bandwidth on the fiber. Thus, as a result of this development, there is extensive bandwidth and communications capability in carriers' backbone networks. Unfortunately, many commercial and residential consumers still access these large bandwidth network through low bandwidth connections. This is known as the “last mile” problem.

Free space optical networks between facilities can provide a solution to the “last mile” problem. These networks are created by positioning nodes on neighboring facilities that are not currently connected to the backbone network and connecting these nodes with optical links. Each node has a transmitter and/or a receiver which transmit and/or receive data in the form of light from neighboring nodes. These links are called “free space” because they travel through the air rather than through fiber optic cables, or some other carrying medium. A plurality of these node links create a network, which is ultimately connected to the backbone network for further transmission. Free space optical communications networks provide a solution while avoiding costly rights-of-way and installations involved in further fiber interconnection, or costly investments in microwave repeater equipment, as well as rights to the suitable portion of the spectrum for microwave systems.

Although free space optical networking provides a superior solution to the “last mile” problems, significant technical challenges are presented in its implementation. To be a viable solution, free space optical networking needs to be relatively easy to install and also very reliable. Both these requirements involve establishment and maintenance of optical links. Therefore, it would be beneficial to have a system and method for establishing and maintaining optical links between optical transceiver nodes in free-space optical communications networks.

### SUMMARY OF THE INVENTION

The present invention is generally directed toward a system and method for providing enhanced features for a communication network. According to one aspect of the invention, a novel communication network is provided. The communication network can be implemented to provide high quality, high-bandwidth communication services to the home, office, or other facility. Advantageously, the communication network can be implemented to provide quick and reliable mechanism and method for establishing and maintaining optical links.

In one form, a method for establishing optical links between optical transceiver nodes in a free space optical communications network is provided. In the method, a map node is provided having a transmitter and a receiver. The map node also has a corresponding uncertainty window. In the method, a reflect node is installed, and a retro-reflector is installed on the reflect node. The map node scans the uncertainty window by transmitting a transmit beam until the reflection of the transmit beam is received by the receiver of the map node. The method also comprises verifying that the signal received by the receiver of the map node is the signal transmitted by the transmitter of the map node. The reflect node is directed to scan its uncertainty space. The method also comprises determining whether a link has been achieved.

### BRIEF DESCRIPTION OF THE DRAWINGS

The present system and method are described with reference to the accompanying drawings. In the drawings, like reference numbers indicate identical or functionally similar elements. Additionally, the left-most digit(s) of a reference number identifies the drawing in which the reference number first appears.

FIG. 1 is a diagram illustrating an example communication network.

FIG. 2 is a diagram illustrating an example implementation of a node.

FIG. 3 is a block diagram illustrating a logical breakout of components that can be included in an example node head.

FIG. 4 is a block diagram illustrating a logical breakout of components of an example node base.

FIG. 5 is a block diagram illustrating a logical breakout of components of an example control processor.

FIG. 6 is a block diagram illustrating the various modules of the pointing software.

FIG. 7 is a block diagram showing the turret task module and the various modules associated with pointing and tracking.

FIG. 8 is a flow chart of a method of operation of the retro reflector acquisition module.

FIG. 9 is a flow chart of a method of operation of the open search acquisition module.

FIG. 10 is a flow chart of a method of operation of the fine acquisition module.

FIG. 11 is a flow chart of a method of operation of the tracking module.

FIG. 12 is a flow chart of a method of operation of the recovery module.

FIG. 13 is a flow chart of a method of operation of the reacquisition module.

### DETAILED DESCRIPTION OF THE PREFERRED EMBODIMENT

In the following description, reference is made to the accompanying drawings, which form a part hereof, and which show, by way of illustration, specific examples or processes in which the invention may be practiced. Where possible, the same reference numbers are used throughout the drawings to refer to the same or like components. In some instances, numerous specific details are set forth in order to provide a thorough understanding of the invention. The invention, however, may be practiced without the specific details or with certain alternative equivalent devices and/or components and methods to those described herein. In other instances, well-known methods and devices and/or components have not been described in detail so as not to unnecessarily obscure aspects of the invention.

A wireless optical communication network utilizes various technologies, for example, free-space optics and radio frequency (RF) or a combination of both, to provide convenient last-mile technology to extend high-bandwidth services from “on-net” buildings to “near-net” buildings.

In general, there are three different network configurations for wireless optical networks. The first is a single point-to-point link, which provides a dedicated, high-capacity link between two terminals. The second is a point-to-multi-point network that includes hub stations and customer premises equipment (CPE). This topology works by placing the hub station on a tall building. Laser signals are then transmitted in a star topology to the surrounding buildings. These buildings receive and transmit the signal to CPEs mounted on the roof or placed in windows.

The third and most reliable type of network configuration is the optical mesh network. This topology is an extension of point-to-point links and best provides last-mile access in dense urban areas and business campus environments. The mesh network is comprised of short, redundant links, eliminating a single point failure and ensuring carrier-class reliability in inclement weather conditions including dense fog conditions.

The invention is directed toward a system and method for providing enhanced features for a communication network. The communication network can be implemented to provide high quality, high-bandwidth communication services to the home, office, or other facility. Advantageously, the communication network can be implemented to provide an interface between the numerous and diverse communication equipment in various homes, offices or other facilities and copper or fiber backbone carrier networks.

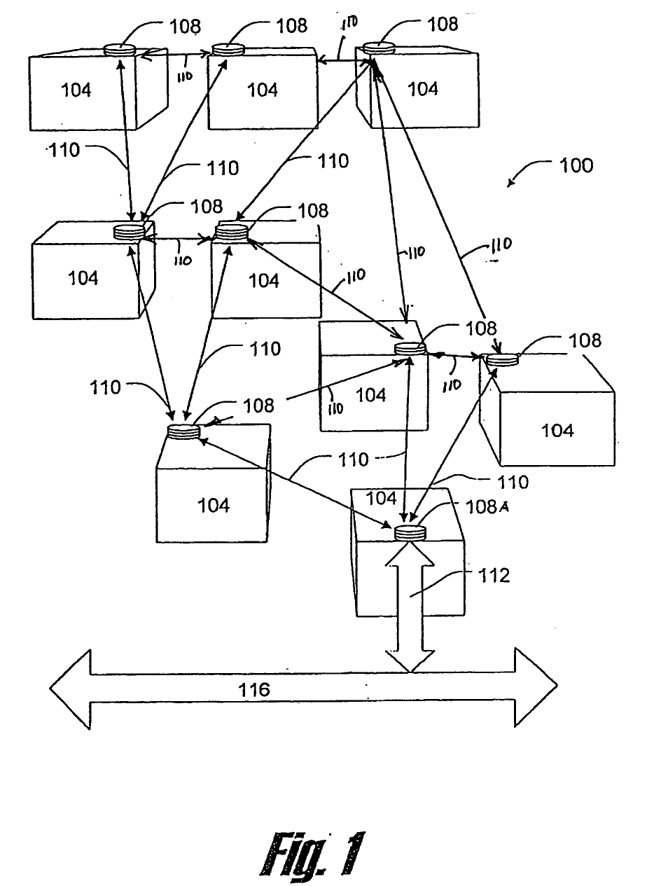

FIG. 1 is a diagram illustrating an example communication network 100. Referring now to FIG. 1, the example communication network 100 illustrated in FIG. 1 can include a plurality of nodes 108, interconnected by communication links 110. According to one example, the network nodes 108 are disposed on facilities 104. Although only one node 108 is provided per facility in the example illustrated in FIG. 1, more than one node 108 can be provided at one or more of facilities 104, depending on the communication requirements, and also, perhaps, depending on the particular facility. An example communication network 100 is described in the patent application Ser. No. 09/181,044 titled “System and Method for Improved Pointing Accuracy,” filed on Oct. 27, 1999, which is hereby incorporated by reference, in its entirety.

The facilities 104 can be buildings, towers, or other structures, premises, or locations. Advantageously, facilities 104 can, for example be homes or offices to which it is desirable to interface one or more backbone networks of one or more common carriers or service providers. The network 100 can provide the interface between the facilities and the backbone network.

The nodes 108 are interconnected with one another by optical communication links 110. In this optical communication, nodes 108 can include one or more optical transmitters and receivers to provide the communication links 110 among the plurality of nodes 108. The nodes 108 can also be implemented such that communication links 110 are RF communication links. Alternatively, the nodes 108 can be implemented with both RF and optical communication links. Although the nodes 108 can be hardwired together, it is preferable that the communication links 110 be wireless communication links to better facilitate interconnection of a variety of facilities.

The number of transmitters and receivers provided at a given node 108 can be varied depending on the fan-out capabilities desired at that node 108. For example, each node 108 can have four transceivers, allowing each node 108 to connect its associated facility 104 with up to four additional nodes 108 at four additional facilities 104. The provision of both a receiver and transmitter (i.e., transceiver) for each fan out of the node 108 allows bi-directional communication among nodes 108.

In examples using optics technology, transceivers at nodes 108 can be implemented using, for example, lasers or light emitting diodes (LEDs) as the optical transmitters and charge-coupled devices (CCDs), photomultiplier tubes (PMTs), photodiode detectors (PDDs), or other photodetectors as the receivers.

The network 100 illustrated in FIG. 1 is illustrated as a mesh network structure. A mesh network is describe in the U.S. Pat. No. 6,049,593 issued Apr. 11, 2000 to Acampora, hereby incorporated by reference in its entirety. Other network structures or geometries can be implemented. For example, a branching tree network structure is also possible. A branching tree network is described in the U.S. Pat. No. 6,049,593 issued Apr. 11, 2000 to Acampora, hereby incorporated by reference in its entirety.

The network 100 can be implemented and utilized to directly connect a plurality of customers in one or more facilities 104 to a high-capacity communication network 116. For example, network 100 can be used to connect the plurality of customers to a copper or optical fiber backbone network. Advantageously, the network can therefore allow the customers to access a high data rate, high-bandwidth communication network from their home, office or other facility, regardless of the existing connection capabilities within that facility. Thus, the network 100 can be implemented to avoid the need to cable a backbone network over the “last mile” to each facility 104.

To accomplish this objective, at least one of the nodes 108 is designated as a root node 108A. The root node 108A includes additional functionality to interface the communication network 100 to a provider network 116 via another communication link 112. For example, the provider network 116 can be a high bandwidth copper or fiber service provider or common-carrier network 116.

The overall management of the communications network 100 can be achieved by a network management application (NMA). The NMA can include a processor and one or more modules.

The term “module,” as used herein, means, but is not limited to, a software or hardware component, such as a field programmable gate array (FPGA) or an application specific integrated circuit (ASIC), which performs certain tasks. A module may advantageously be configured to reside on an addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

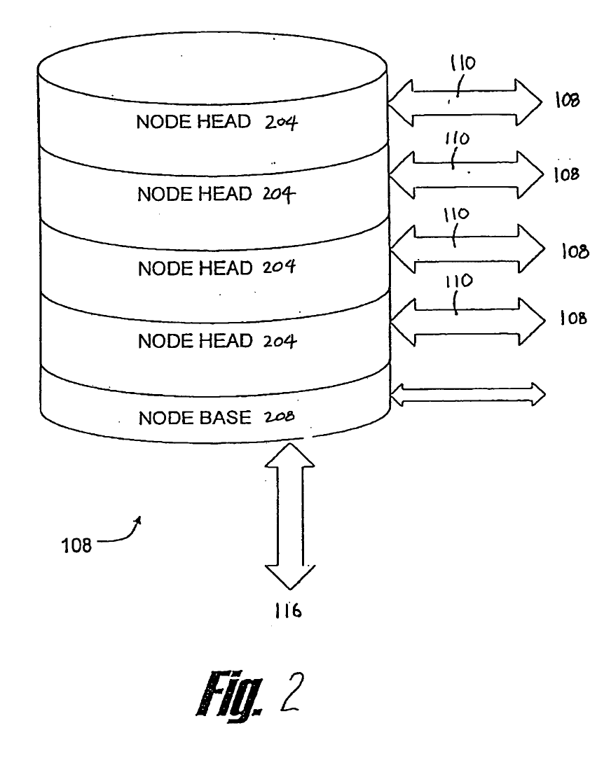

Nodes 108 are now described in more detail. FIG. 2 is a diagram illustrating an example implementation of a node 108. The example implementation of the node 108 illustrated in FIG. 2 is generally cylindrical in shape and includes four node heads 204 and a node base 208. The node heads 204 can each include a transceiver to facilitate communication with one or more other nodes 108 in the network 100. For example, there is a single transceiver in each node head 204, and each node head 204 provides a communication link 110 with one other node 108 in the network 100 at a given time.

Each transceiver has both a receiver and a transmitter, providing two-way communications. Alternatively, a node head 204 has just a transmitter or just a receiver, thereby providing one-way communications. Additionally, it is possible for one or more node head 204 to include more than one transceiver, or an additional receiver or transmitter to provide additional capabilities. As stated, the transceivers are optical transceivers, however, alternative wireless transceivers can be implemented operating at wavelengths other than optical wavelengths.

The example illustrated in FIG. 2 includes four node heads 204. Thus, in this example and where each node head has a single transceiver, node 108 so configured can communicate with up to four other nodes 108 at four separate locations. Other numbers of node bead 204 can be included, depending on the fan-out capability desired for the node 108. For example, the node 108 can be configured with four node heads 204, each with a two-way transceiver.

Each node bead 204 can include a pointing mechanism such that it can be rotated to point to a designated other node 108. For example, such pointing can be performed in both azimuth and elevation: Each node bead 204 can be independently pointed to a designated node 108.

As described in greater detail below, pointing includes various functions, including acquisition, tracking and recovery. Acquisition is the process of the node head 208 finding, or acquiring, the paired node head 108 to establish the optical link 110. Tracking occurs once the link between paired nodes have been acquired, and involves adjusting the pointing angles of the transceivers in the node heads 204 to track movements of the nodes. Recovery is a process through which a link can be reestablished when lost.

Still further, the example implementation illustrated in FIG. 2 is substantially cylindrical in shape. This facilitates pointing to other nodes in a full 360-degree circle. One advantage of this shape is that an optical communication beam is always at a substantially right angle with respect to the cylindrical housing, regardless of pointing. This helps to maximize the transmitted beam power. Note that the housing for each node bead 204 could also be shaped as a portion of a cylinder in the vertical direction to allow perpendicular passage of the beam through the housing as the beam is pointed in the elevation direction. Of course, alternative shapes for the housing can be implemented as well.

Note that in one example, one or more node heads 204 can be implemented with the communications equipment to allow them to communicate with equipment other than another node 108. This equipment can be implemented using, for example, wireless RF communications or other communications techniques. Alternatively, the node heads 204 can dedicated to inter-node communications via communication links 110.

Node base 208 includes the electronics and mechanics to provide a communications interface between, for example, a network 116 and the one or more node heads 204. A communications interface to perform protocol or format conversions can be included in the node base 208 as well as mechanics to drive the pointing of one or more node heads 204.

One or more node bases 208 can be included in a node 108 to provide, among other functions, control of node 108 and to interface node 108 to facility 104 or a network 116. Alternatively, these functions can be delegated among one or more of node heads 204,

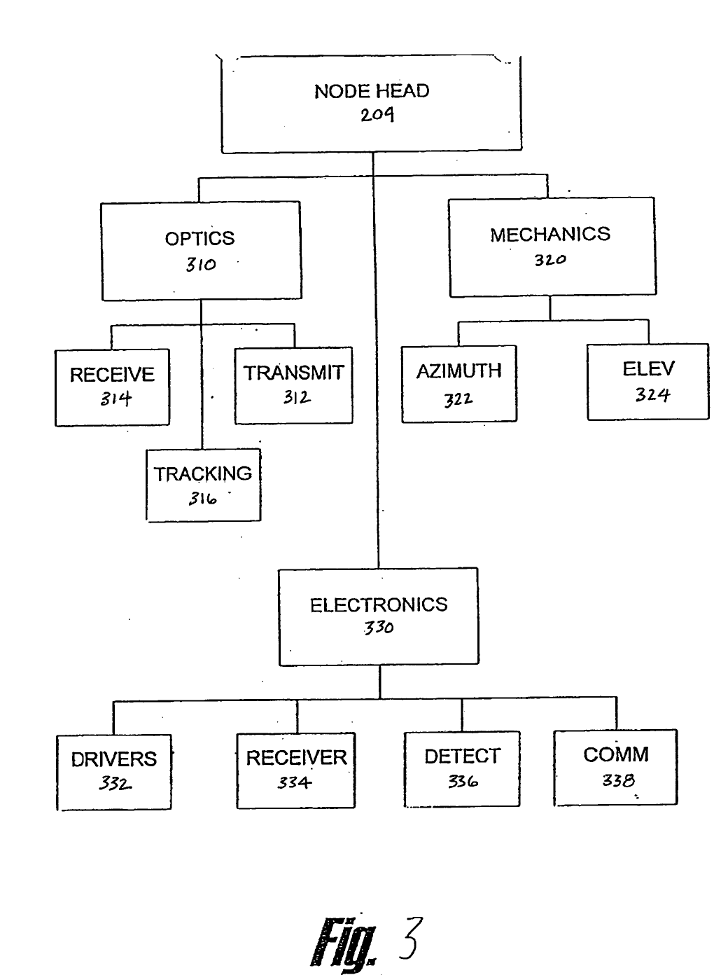

The details of the node heads 204 and node base 208 are now described. FIG. 3 is a block diagram illustrating a logical breakout of components that can be included in an example node head 204. This logical grouping is provided for discussion purposes only, and should not be interpreted to require a specific physical architecture for a node head 204. FIG. 3 illustrates communicates among node heads 204 in different nodes 108 via an optical link 110.

Referring now to FIG. 3, the example node head 204 can have three logical groupings of components: optics or optical components 310, mechanics or mechanical components 320, and electronics or electronic components 330. For node heads 204 having transceivers, the optics can include transmit optics 312, receive optics 314 and tracking optics 316. The optics can also include associated electro-optics such as, for example, a laser transmitter, a CCD detector, and so on. The transmitter and detector or receiver may be boresighted to each other during manufacture, such that bi-directional pointing accuracies can be established and maintained. One or more transceiver components can be eliminated without rendering the node head nonfunctional. For example, if the tracking optics 316 are eliminated, tracking, as described below, can be achieved with the transmit and receive optics only.

The mechanics 320 can include gimbal platforms and an enclosure to isolate the electronics from the elements. The gimbal platforms can include an azimuth gimbal 322 and an elevation gimbal 324. This azimuth/elevation configuration allows pointing to nodes 108 at a wide range of bearings. Each node head 204 is capable of rotating 370° in azimuth and ±20° in elevation for pointing to another node 108, although other ranges are permissible.

Note that other platforms can be used, including, for example, X-Y optical mounts. A motor or other drive mechanism can be used to drive the gimbals. The motor is a belt-driven stepper motor, although direct drive motors or geared arrangements can be used as well. Optical encoders and limit stops/switches can be included to enable precise pointing.

The housing, may have an acrylic housing, transparent to the wavelength of communication link 110. The housing can also serve as a filter to filter out unwanted noise from wavelengths other than that of communication link 110. For example, where the communication wavelength is 780 nanometers (nm), the housing can provide a 780 nm band pass filter. Each housing is approximately 4.5 inches high and twelve inches in diameter, although other dimensions are possible. The exterior dimensions are minimized to the extent possible based on the size and placement of components of the node head 204.

The electronics 330 can include a transmitter driver 332, a receiver 334, a detection electronics component 336, and a communications component 338. The transmitter can be a semiconductor laser diode modulated in the on-off keyed (OOK) mode at approximately 780 nm wavelength at approximately 20 milliwatts (mW) average power. The divergence of the beam is about 1.5 milliradians (mrad), and is eyesafe at the aperture. Of course, alternative technologies can be implemented with transmitters operating at different wavelengths, power, and divergence.

The receiver can be implemented using an optical detector. For example, the receiver can be implemented as a positive-intrinsic-negative (PIN) photodiode or avalanche photodiode detector (APD) with a 50 nm aperture, to detect the total amount of transmitter power received. Although more sensitive than the PIN photodiode by approximately 10 dB, the avalanche photodiode is generally more complicated to implement. As such, the PIN photodiode detector is favored in applications where the link margin permits. Other detectors can be utilized to detect energy at optical or other wavelengths depending on the application.

The detection electronics can include, a quadrant PIN photodiode detector, with a 2 degree field of view, and located in the optical path of the receiver. Preferably, the quadrant detector is separated from the receiver by a 4% beamsplitter. The 4% fraction of the received signal is imaged onto a quadrant detector that generates an error signal, depending on the relative signal strength in each quadrant. The error signal is processed to determine a pointing offset. The pointing offset is used to generate an error signal to drive the azimuth and elevation gimbals 322, 324 to correct for the pointing error. In addition to control and communication functions for the node head 204, a processor can be used to maintain the tracking loop, as will be discussed in greater detail below.

The photodetector can be located at the focus of an 80-mm focal length, 50-mm diameter doublet lens. A 20 mm diameter, 20 nm bandwidth bent pass filter centered at 780 nm is located directly in front of the receive photodiode which is 600 microns in diameter. Light collected by the receive lens is imaged to a spot on the receive photodiode.

The communication electronics 338 is used to interface the node head 204 to node base 208. A bus can connect the plurality of node heads 204 to the node base 208. In that case, a multiplexer can be provided as part of communication electronics 338 to allow communications among the various elements over a shared bus.

Each of these elements is now described in greater detail. As stated above, the transceiver can be mounted on gimbals to facilitate pointing. In that case, the transceiver is mounted on an elevation gimbal, which is in turn mounted on an azimuth platform. The elevation gimbal can provides a field of movement of +20 degrees, and the azimuth platform can rotate a total of 370 degrees about an axis. Thus, provided another node 108 is within the line of sight of node head 204, and within +20 degrees of elevation, the two nodes 108 can be communicably connected.

The gimbal axes can be manipulated by belt-driven stepper motors. The stepper motors can be controlled by clock and direction signals provided, for example, by a processor in node base 208. Stepper motors cause the platforms to rotate in azimuth or elevation in discrete steps. Preferably, the platforms can be driven to a resolution that is approximately 10 times finer than the divergence of the transmit laser. Thus, where the divergence of the transmit laser beam is 1.5 mrads, the resolution of the gimbals is about 150 microradians (μrads).

Preferably, in one realization, the stepper motors drive toothed timing belts that are connected to the azimuth and elevation gimbals through toothed pulleys. Although other drive mechanisms can be utilized, the toothed belt mechanism is both highly accurate and cost effective. A toothed belt arrangement provides an arrangement that minimizes belt slippage. The motors have about 1.57 mrad per step resolution and an appropriate turn-down ratio. The azimuth turn-down ratio can be, for example, 9.28:1, and the elevation ratio is 12:1. This provides a spatial resolution of 169 grads for azimuth and 130 grads for elevation. Each motor can have a internal gear drivetrain to reduce the motor armature motion. For example, the gearing provides a reduction of 1000:1. This allows the motor to maintain its position, even when its drive coils are not energized. Calibration at set up, or otherwise, using limit switches to provide reference points is taken up with greater detail below.

The gimbals are indexed to an absolute reference point to provide a reference for determining pointing. The reference point can be provided by limit switches positioned at the extreme ranges of motion on either axis. Thus at set up, or other calibration time, the gimbals are instructed to move to their limit positions, sending a signal to the microprocessor indicating their absolute position. The microprocessor can then use a signal from gimbal position encoders to maintain positional information and to drive the gimbals to a desired position.

As stated, the housing of node head 204 can be an acrylic cylinder that is transparent to the 780 nm communication signal wavelength. The acrylic can be deep red to provide thermal protection to the inner components. The top and bottom caps of the enclosures can be made from, for example machined aluminum. They can be provided with seals to keep out moisture or other undesirable elements. The seals are O-ring grooves into which the top and bottom edges of the acrylic cylinders fit. A rubber, rubber-like or polymeric O-ring can be provided in the groove to provide a good seal. A single acrylic cylinder can surround each of the node heads 204 in the node stack. The stack can be purged with dry nitrogen and sealed with a sealant. In that case, there is sufficient space above the tope node bead 204 to provide adequate air circulation. Although not strictly necessary, a thermoelectric or other temperature control device can be provided to maintain a desired equilibrium temperature. One equilibrium temperature that may be used is of approximately 12 degrees C. above the ambient temperature.

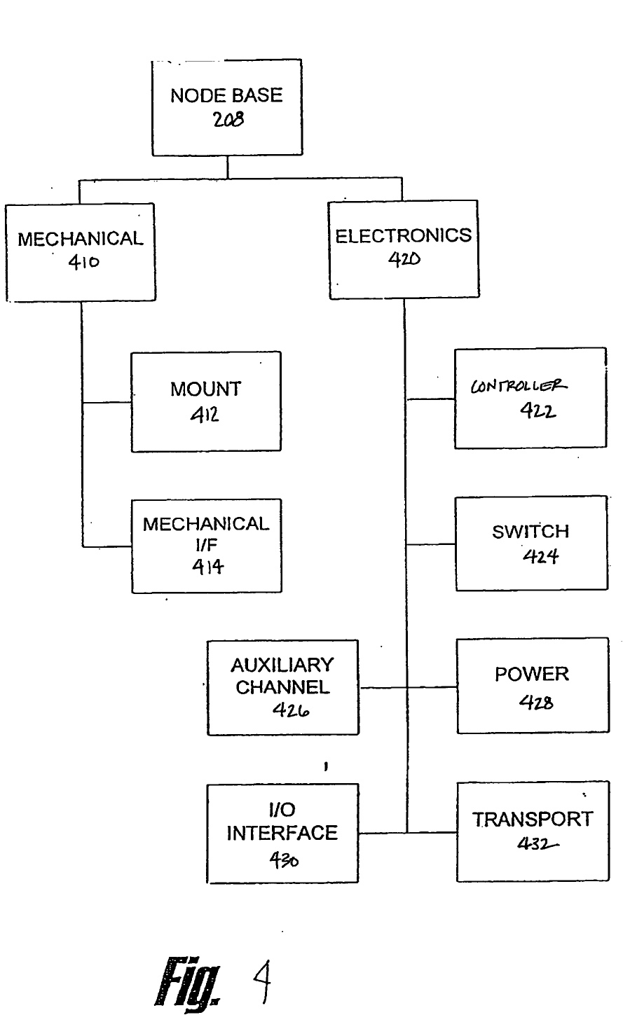

One or more node bases 208 can be included in a node 108 to provide, among other functions, control of node 108 and to interface node 108 to facility 104 or a network 116. Alternatively, these functions can be delegated among one or more of node heads 204. FIG. 4 is a block diagram illustrating a logical breakout of components of an example node base 208. This logical grouping is provided for discussion purposes only, and should not be interpreted to require a specific physical architecture for a node base 208.

Referring now to FIG. 4, node base 208 includes mechanical components 410 and electronics or electrical components 420. The mechanical aspects of node base 208 include a mount 412 to mount node base 208 to facility 104, and structure utilized to interface power to the node base 208. Electronics 420 can include, in the illustrated example, a controller 422, a packet switch 424, and auxiliary channel 426, power 428, I/O interface 430, and transport interface 432. Each of these logical components is now described.

Base mount 412 provides a physical mount by which a node 108 can be mounted to the facility 104 premises. The base mount 412 can be implemented to provide at least two functions. One function that the base mount 412 can perform is that of leveling or otherwise adjusting the position or orientation of node 108. To this end, the base mount 412 can include a leveling device such as, for example, a mechanical ball joint apparatus, or other apparatus to allow leveling of the unit.

Electronics elements 420 are now described. An auxiliary channel 426 can be included among electronic elements 420 to provide communications between a node 108 and another entity separate from or in addition to communication link 110 and network 116. The communication link 110 provides in-band communication while the auxiliary channel 426 provides out-of-band communication. The auxiliary channel 426 can be implemented, for example, via Ethernet, serial or infrared connections. The provision of such an auxiliary channel 416 can be provided for various purposes. One purpose would be to pass data to or from a new node 108 during installation of that node 108. Thus, before the node is interfaced to facility 104 or network 116, auxiliary channel 426 can be utilized to allow that node 108 to communicate with other entities to facilitate installation or to share data for other purposes. For example, the auxiliary channel 426 can be utilized to download the system image of the node from a network server.

Additionally, an auxiliary channel 426 can be used to provide an auxiliary communication channel with node 108 for communication during the field life of node 108. For example, the auxiliary channel 426 can be used to provide status or other signals to another entity, or to receive control signals or updates from another entity. The other entity referred to in this description is, for example, a central office or other office through which the network 100 can be controlled, monitored or adjusted. Auxiliary channel 426 can be used during installation and integration of a node 108 into network 100, or during operation of a node 108 within network 100.

Various communication formats or protocols can be used to provide the auxiliary channel 426. For example, the auxiliary channel 426 can be hard-wired such as a hard-wired telephone line. Alternatively, the auxiliary channel 426 can be provided as a wireless RF communication link such that line of sight communication is not required.

Auxiliary channel 426 may also be used to communicate with a node 108 if that node 108 has otherwise “disappeared” from the network. Thus, if the other transport channels (i.e., channels 110) of the node 108 are not functioning, auxiliary channel 426 can be used. For example, auxiliary channel 426 can be used to send communications to and receive communications from the otherwise disabled node 108. In this application, auxiliary channel 426 can send status information back to the central office, which may give technicians an indication of a problem that may exist with the node 108. Thus, if a technician is dispatched to facility 104 to repair the disabled node 108, that technician can be better prepared having this information obtained before leaving the office. The auxiliary channel 426 can be battery powered or solar powered such that it can operate even in the event of a power failure elsewhere in the node 108.

Referring still to FIG. 4, switch 424 is provisioned to accept network management commands such that it can create virtual paths. In other words, the routing tables of switch 424 are configured such that they are responsive to software-issued commands, allowing them to translate a virtual path identifier of each arriving cell to a predetermined routing. The switch 424 can provide multiple, bi-directional data paths, for example 9×9 bi-directional data paths, between the node heads 204 and the customer facility 104. Data to/from any of the node heads 204 can be routed by the switch 424 to/from any drops to the customer facility 104. FIG. 4 illustrates a drop 415 from the switch 424 to the customer facility 104. In addition, the switch 424 can include diagnostic features, including an ability to report cell loss statistics to the central office. Such statistics can be included in the data stream via communications network 116, through an auxiliary channel 426, or otherwise.

Switch 424 can be an ATM switch. ATM switches are generally well known in the art, and are therefore not discussed in more detail here. Generally speaking, the ATM switch detects an arriving cell, aligns boundaries of cells arriving on multiple input lines, inspects the virtual path identifier (VPI) to determine the routing for a cell, converts the serial stream into a word parallel format, and time multiplexes the words onto time slots on a shared bus. A routing processor provides routing translation instructions to routing tables or accepts arriving virtual path identifiers from line interfaces to provide the correct routing instruction. A plurality of routing elements can be provided for each output. The routing element inspects the routing instruction associated with each word appearing on the shared bus and delivers to its corresponding output cue only those cell segments intended for that output.

In the ATM protocol, each output cue reassembles the arriving word into ATM cells and delivers each ATM cell to the corresponding output port in serial format.

Referring to FIG. 4, I/O interfaces 430 can provide the ability to interface node base 208 to node heads 204 or other external devices. The access port can be provided at the top of the top node head 204 to provide easy access to the I/O link after the node 108 has been installed at a facility 104.

A diagnostic I/O interface can be included which provides a communication link from node base 208 to an installation fixture or to an external diagnostic device. Although any of a number of link types can be provided, an optical link is provided, in order to be able to maintain enclosure integrity. Thus, the access port for the diagnostic I/O interface is a window transparent to infrared radiation. The diagnostic I/O interface can be infrared-based, such as IrDA (Infrared Data Acquisition) or serial-port based, such as RS-232 serial port.

A data input/output section can also be provided to allow data to be exchanged between node base 208 and node heads 204. Where the node heads 204 are addressed, the data I/O interface can include a plurality of address lines that enable selection of a particular node head 204. This addressing capability is useful where the communication between node heads 204 and node base 208 are multiplexed communications. Of course, where addressing is not necessary, these address lines do not need to be provided.

The address lines can also be provided and used to allow data to be written to various components in node heads 204 such as, for example, digital potentiometers, registers, or other devices or components. Another function of the data I/O interface 430 can be to digitize signals coming from node head 204 in the analog form such that they can be interpreted by a processor in node base 208. Where address lines are used, the number of lines can be determined based on the number of devices or components being addressed.

The electronics 410 of node base 208 can also include a controller 422. The controller 422 can be a processor-based controller 422. A processor-based controller can be implemented using one or more microprocessors to provide the control and operation of node base 208. Additionally, controller 422 can control functions and operations of one or more node heads 204. Microprocessor controller 422 in this example can also include memory and interfaces to packet switch 424, auxiliary channel 426, and I/O interface 430.

The memory associated with the controller 422 can be implemented using non-volatile memory technology such that data is not lost when power is removed, i.e. persistent storage. For example, the persistent storage can be implemented using FLASH memory. FLASH memory is a type of memory similar to electrically erasable programmable read-only memory (EEPROM) wherein the non-volatile memory is programmed after its manufacture using electrical signal. However, FLASH memory, unlike the EEPROMs, is erased in blocks and therefore often used as a supplement to hard disks. Alternatively, the persistent storage can be implemented using a battery-backed complementary metal-oxide semiconductor random access memory (CMOS RAM). The data stored in the database manager global database may include calibration variables and the stored state of the turret, if any.

One function of the controller 422 is to accept communication signals from network 116 and provide these signals to one or more node heads 204 for routing over network 100. These functions can be performed by controller 422 regardless of the data formats chosen for network 116 and network 100. However, it is as likely that controller processor 422 will be asked to perform some level of protocol conversion, as different communication protocols can often exist on network 116 and network 100.

Another function that can be accomplished by controller 422 is to receive communications from a communications link 110 and provide those communications in a telecommunications protocol acceptable by the end user in facility 104.

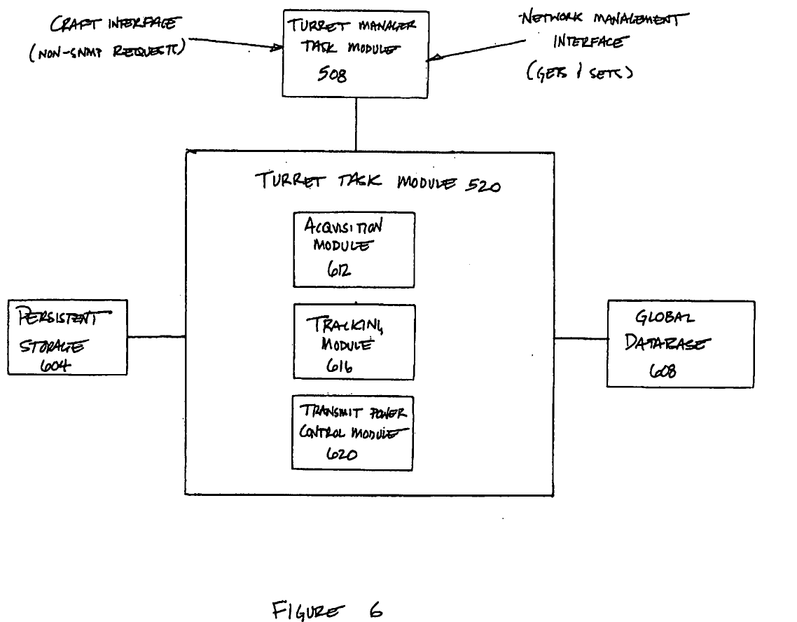

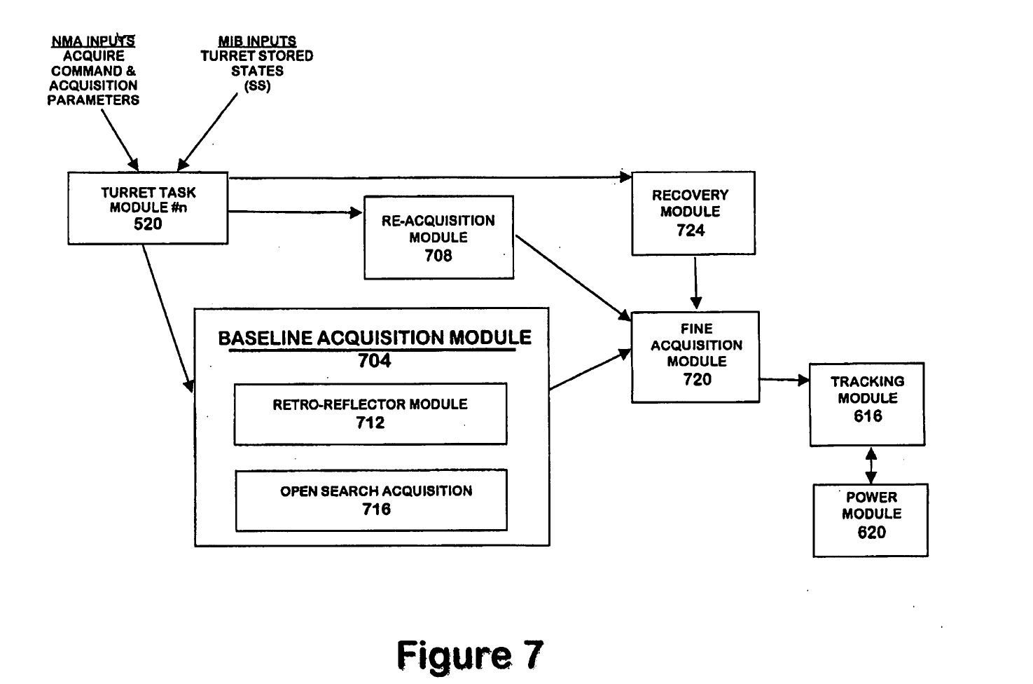

As mentioned above, one of the functions performed by the controller 422 is the pointing of the transmit optics 312 and receive optics 314 of each node head 204 so that optical links 110 can be established and maintained with the corresponding transmit and receive optics 312, 314 between the paired, adjacent nodes 108. Pointing is accomplished by pivoting these optical components of a node, or turret, about two axes: the azimuth axis (AZ), and the elevation axis (EL). Pointing will be discussed in greater detail below with respect to FIGS. 6 and 7. As defined above, AZ is the clockwise angle from the line-of-sight of the transmit beam to the clockwise limit switch closure position. EL is the angle of intersection between the plane of the node base to the line-of-sight of the transmit beam. Angles above the node plane are defined as positive, below negative. In a single node head, the transmit optics 312 and receive optics 314 are normally bore-sighted, or co-aligned.

Unfortunately, there are various sources of positional error encountered by the node head which affect acquisition. One source of error in pointing angles is the tilt angle at which a node may be installed. This angle is measured during installation and corrected for in any pointing commands implemented by the controller 422.

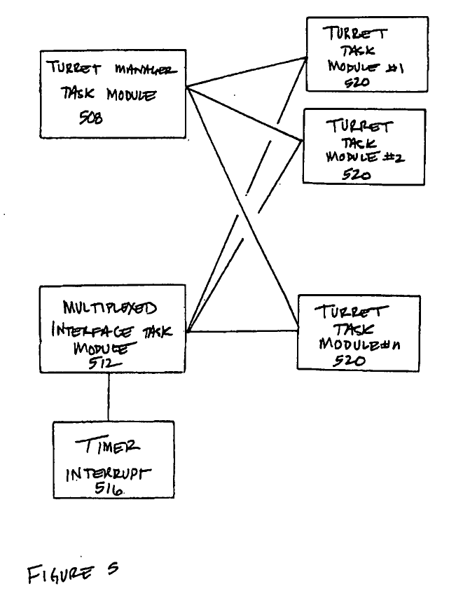

Referring now to FIG. 5 several aspects of the control processor 422 will be discussed in greater detail. FIG. 5 is a block diagram illustrating a logical breakout of modules that may run on the controller 422. These modules may be initiated by a root task module (not shown), and may include a turret task module 508, a multiplexed interface task module 512, and a plurality of turret task modules 520. The turret manager task module 508 is configured to create and initialize an arbitrary number of turret task module(s) 520 for each turret 204 in the node 108. The turret manager task module 508 is also configured to coordinate turret task modules 520 when the modules 520 cannot run independently. The turret manager task module 508 can also provide a single interface for management functions.

Initialization of a turret task module 520 includes setting the physical parameters, configuration and state information. Physical parameters are set based on the turret model number read from the physical turret. Configuration and state information, discussed in more detail below, are obtained from other sources. Initialization also includes setting the initial calibration of the turret position relative to the limit switches. The turret task 520 is configured to maintain the calibration of the turret across resets and power cycles. The turret task modules 520 include various pointing and transmit power control modules, described in more detail below, that perform the various pointing and transmit power functions of the node 108.

The multiplexed interface task module 512 multiplexes data requests for the individual turrets through a shared analog-to-digital input and digital output. The multiplexed interface task module 512 also handles input and output requests from self-test and environmental monitor and control modules (not shown). The multiplexed interface task module 512 also interfaces with the timer interrupt 51.6, which is used to control the functioning of the stepper motors that drive the gimbals.

Referring to FIG. 6, an example turret task module 520, generated by the turret manager task module 508, is shown in further detail in FIG. 6. The turret manager task module 508 is shown hierarchically above the turret task module 520 because it manages the turret task modules that are generated for each turret 204 of each node head 108. The turret manager task module 508 is also a conduit through which the NMA provides commands and requests status. Commands and status requests can be in the form of simple network management protocol (SNMP) “sets” and SNMP “gets.” The turret manager task module 508 can also be configured to provide a conduit for non-SNMP requests, such as may come from the “craft interface.” The “craft interface” is a control interface that can be used by, for example, a technician for remote diagnostics. The “craft interface” may be a telnet, a serial, or an Ethernet interface, for example.

In addition to receiving data from the turret manager task module 508, the turret task module 520 may receive data from other data sources. For example, persistent storage 604, which, as discussed above, may be any of several forms of memory connected to the controller 422, may be provided in the node. The persistent storage 604 may contain one or more databases that contain data that are of interest to the node in which the storage is situated. This may include, for example, best estimate pointing angles, turret acquisition states, current AZ and EL angles, and whether the AZ and EL angles are valid. Another data source can be a global database 608 that may be accessible to one or more turret as well as the NMA. This database 608 may include system-wide information, such as model number, turret quantity, turret type(s), and P addresses.

Turret task module 520 also comprises various submodules, including an acquisition module 612, a tracking module 616, and a transmit power and control module 620.

The acquisition module 612 is configured to properly aligning both communication lasers in an optical link so that each laser (transmitter) illuminates the other's receiver and data is exchanged reliably. To do this, the acquisition module processes information relating to the expected location of the turrets, errors inherent in the expected location of the turrets, which can induce pointing angle errors, the size and divergence of the lasers and the size of the receive aperture. To adjust for pointing angle errors, it is useful for the acquisition module 612 to know beam spot size at a given distance from the transceiver. In general, beam divergence, γ, is a measure of how much the beam spreads out over distance. As mentioned above, beam divergence is assumed to be 1.5 mrad, but of course other beam divergences may also function. One transmitter that can be used in the system has an emitted spot size, A, of 5 cm, which also may vary without affecting the function herein described. Given these dimensions, the range to an Effective Point Source (EPS), REPS can be calculated by the acquisition module as follows:
R_{EPS}=A/Sin(γ) Eq. 1

At any range, R, in front of the aperture exit, the projected beam spot size S can be calculated from:
S=R*Sin(γ) Eq. 2

For small angles γ, this can be approximated as R*γ, where R=(R_{EPS}+R_{S}), R_{S} being the distance from the turret exit point to the target, for example, the paired node head receiver at the adjacent node. Thus,
S=(R_{EPS}+R_{S})*Sin(γ) Eq. 3
or
S=R_{EPS}*Sin(γ)+R_{S}*Sin(γ) Eq. 4
or
S=A+Rₛγ Eq. 5

It is believed that for angles less than 500 mrad, the error introduced by approximations in the above formula is less than about 5%. Movement of the spot can be achieved by an azimuth rotation of the turret. The amount of movement of the spot M for a given rotation β at a distance Rₛ is given by the following formula:
M=Rₛ sin η Eq. 6

This variable can be approximated for small angles as:
M=Rₛβ Eq. 7

The fraction of the spot size that is moved for a small change in angle, γ, is given by
M/S=Rₛβ/(A+Rₛγ) Eq. 8

At large range, (A+Rₛγ) goes to Rₛγ and MIS goes to (Rₛβ/Rₛγ), or β/γ. Therefore, a step size of one-half the beam divergence results in a move of half a spot size or less. At shorter ranges, the denominator of equation EQ. 8 remains (A+Rₛγ), and thus a given angular movement results in a smaller proportional movement of the spot size. This improves the pointing resolution for a given angular step size. It also means that at shorter ranges, a larger movement is required in order to get independent measurements at the receiver 334.

As mentioned above, the acquisition module 612 is configured to locate the pointing angles for a turret in a link such that sufficient signal is delivered from a transmitter in a first transceiver to the corresponding receiver on the other end of the link to allow the receiver to demodulate the data accurately enough to exchange control signals between the two nodes. This requires alignment of both the transmitter and receiver of both of the paired nodes. Because the transmit and receive optics are closely co-aligned on each turret, aligning the transmitter causes the receiver of a node head to also be aligned. The converse is not necessarily true, however, because the receive aperture is generally much larger than the beam divergence.

A transmitter is considered aligned when the spot projected by the transmit laser illuminates the receiver lens on the other turret. The spot does not need to be centered on the receiver but enough power must be delivered to the receiver for it to demodulate the data. A receiver is aligned when light arriving from a source is focused on the detector. Because the detector is much larger than the focused spot, the lenses of the receiver are able to focus light arriving from a range of positions onto the detector. This range of position is the receive aperture.

Although a detector may accommodate a range of positions, it is possible for a beam transmitted from a first turret's transceiver onto the receive lens of a second turret's transceiver to be focused at a point not on the second transceiver's receiver detector. In that case, the second transceiver will not receive a signal from the first transceiver. When this occurs, the first transceiver is said to be outside the receive aperture of the second transceiver. However, because the second transceiver can rotate about the azimuth axis, the detector can be moved to one of a range of positions where the transmitted beam of the first transceiver is focused by the lens of the second transceiver's receiver, onto the detector. The second transceiver then receives the signal from the first transceiver.

Although the second transceiver can receive the signal from the first transceiver when the second transceiver is so rotated, the first transceiver's receiver may still not be able to receive the signal sent by the transmitter of the second transceiver. This is due to the larger size of the detector as compared to the transmit beam spot size. This makes acquisition more difficult when the first transceiver requires feedback from the second transceiver to establish whether the second transceiver is receiving signal from the first transceiver.

Small positional errors and mechanical imprecision in each turret, known as ephemeris errors, can manifest as pointing angle errors, and can complicate acquisition. The acquisition module 612 is uniquely configured to compensate for such errors. For example, for a short range applications where the adjacent nodes are 30 meters apart and for position uncertainty of one meter per node, the pointing angle error is 66.7 mrad. This value is calculated as the arcsine of the sum of the nodes' positional error divided by the range. For short ranges, this error dominates other errors, while for long range it is relatively less important. This error may be determined by using various components at installation. For example, an installation fixture may be used when each node is installed which may have components specially designed to determine this error, for example a DGPS, compass and tilt-meter.

For each transceiver an uncertainty region may be defined. If, as stated above, the ephemeris error is as much as 66.7 mrad, the receive aperture is 7.5 mrad and the transmit beam divergence is 1.5 mrad, the uncertainty region is approximately 9 receive apertures or 44 transmit beam widths. Because both nodes of a pair must be aligned, the uncertainty space is the square of the uncertainty regions. This uncertainty region can lead to unacceptable installation times as the paired nodes search their uncertainty regions for each other, especially for relatively close nodes.

While the acquisition module 612 is configured to establish an optical link, the tracking module 616 is configured to maintain the optical link so that data may continue to be exchanged over the link. Once a link is acquired, the turrets must adjust their pointing to track movements of the nodes, which can arise from thermal expansion or settling of buildings, for example. Although anticipated to be small, these node movements may be larger than a beam width. Also, these movements are anticipated to be slow, i.e. sub-hertz. Being able to correct for these movements, or track, improves link availability and reduces the number of post-installation technician visits, etc.

Tracking relies on fine resolution of the transmit pointing stepper motor, i.e. the step size is much less than the size of the receive aperture. As a result, the transmitter gimbal must be moved by multiple steps to move the illuminated spot across the receive aperture. By measuring the receive power at each step, a power density profile of the spot can be generated, revealing the relative position of the spot. The system has enough beam stepping resolution to profile the power levels about a non-centered spot without losing connectivity.

When a beam is nearly centered or centered on the receive aperture, the power levels detected by the receiver are maximized. When the transmitted beam spot is shifted slightly, the power level drops. The tracking module 616 is configured to observe such power level changes and react to them by shifting the transmit beam to maintain connectivity.

A transmit power control module 620 is configured to adjust the transmit power as needed. The power control module 620 is configured to maintain an adequate signal-to-noise ratio (SNR) while keeping the far end receiver operating in its linear range and minimizing the transmit power so as to maximize the life of the transmit optics. The SNR is calculated as 622 envelope receive power divided by total Rx power. 622 envelope receive power is a measure of the received strength of the modulated signal. This is measured by removing any DC signal and measuring the depth of the modulation of the signal in the transmission frequency band.

FIG. 7 is a block diagram showing the turret task module 520 and its various submodules associated with pointing, tracking, and power control. For example, the various modules dedicated to acquisition are shown in more detail. The turret task module 520 includes a baseline acquisition module 704, a re-acquisition module 708, a recovery module 724, a fine acquisition module 720, a tracking module 616, and a power control module 620. The baseline acquisition module further comprises a retro-reflector module 712 and a open search acquisition module 716. The retro-reflector acquisition module 712 can implement a method or process of operation by which a newly installed node is initially acquired using at least one retro-reflector to reduce the time required for the newly installed node to be acquired. The retro-reflector acquisition process is advantageous for short range acquisition.

As described above, the turret task module 520 receives various inputs from the NMA through the turret manager task module 508, from persistent storage 604, and from the global database 608. These inputs, as discussed above, can include calibration parameters. They can also include a turret stored state value. The turret stored state represents the state of the optical link for the associated turret and is set to disabled, idle, or recovery. The state value can be stored in persistent storage 604 and it can be changed by a NMA command. Other states may also be used without changing the function of the system and method.

The disabled state is the default state upon initial power up. The disabled state puts the turret in an inoperative, minimal power configuration. The disabled state is exited upon command from the NMA.

The idle state provides for the execution of calibration and off-line self test. Persistent storage can also maintain a record of the current pointing angle and whether the pointing angle is valid. The turret state can only transition from idle or disabled to recovery if the necessary pointing information to enter the recovery state is valid.

If the turret state is idle, the turret can enter the baseline acquisition module 704, or the reacquisition module 708. As mentioned above, the baseline acquisition module 704 comprises two sub-modules: the retro-reflector acquisition module 712 and the open search acquisition module 716. The acquisition module 612 may further comprise a fine acquisition module 720. Once the baseline acquisition module 704, the reacquisition module 708 and/or the fine acquisition module 720 have been implemented, the tracking module 616 can be implemented. The tracking module 616 and the power control module 620 are closely related and will be discussed in more detail below.

The recovery module is configured to re-establish a link that has already been acquired. Thus, if the turret stored state is either recovery or tracking, the turret task module 520 activates the recovery module 724. After the recovery module 724 is implemented, the fine acquisition module 720 can be implemented, followed by the tracking module 616, and power control module 620.

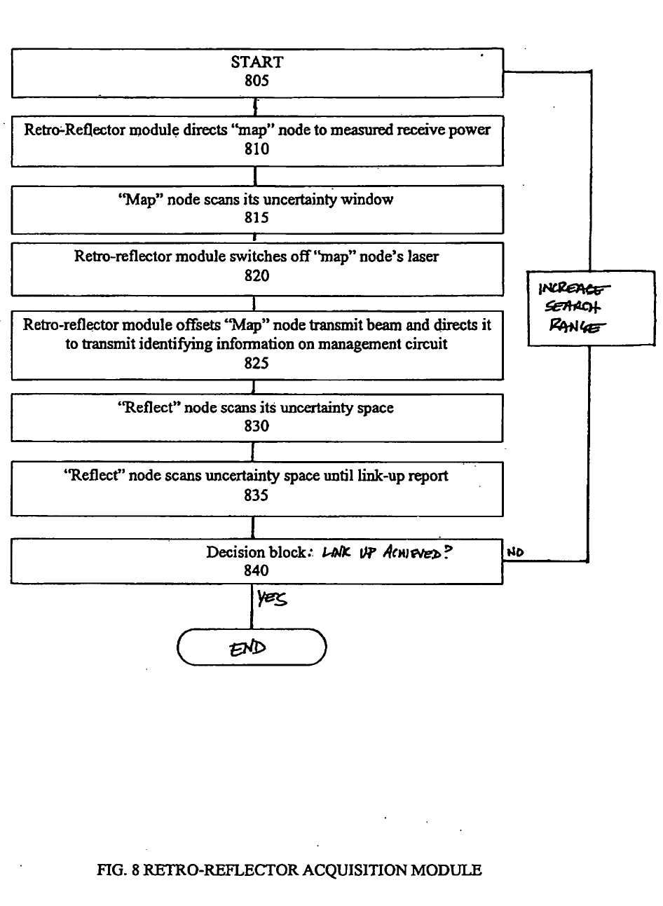

FIG. 8 is a flow chart of a method or process of operation which can be implemented by the retro-reflector acquisition module 712. This process can establish an optical link between a node that has already been installed in the network, called the “map” node, and a node that has just been installed, called a “reflect” node. The process employs at least one retro-reflector mounted on the “reflect” node to reduce the time required for the newly installed node to be acquired. The retro-reflector acquisition process is advantageous for short range acquisition. The process implemented by the retro-reflector acquisition module 712 begins at start block 805.

Prior to start block 805 the retro-reflector acquisition module 712 in a node being installed receives acquisition parameters from the NMA. As was mentioned above, these variables include the calculated azimuth and elevation angles, as defined above, the IP address of the node being installed as well as the network node identification number (NNID) of the nearby node to which it communicates, i.e. the adjacent node. The retro-reflector acquisition module 712 of the node being installed also receives the range and search parameters from the NMA. The retro-reflector acquisition module 712 in the node to be installed accepts the “reflect” role as assigned by the NMA. Also, prior to the start block 805, the retro-reflectors are installed on the “reflect” node.

In a step 810, the retro-reflector module 712 in the “map” node, i.e. the already-installed node, directs the “map” node to measure total receive power (rx) and 622 receive envelope power (RSSI), which, as discussed above, is a measure of the strength of the received modulated signal. These measurements are made at pointing angles that are calculated by the NMA, based on the ephemeris data, and provided to the “map” node prior to the start block 805 by the NMA.

In a step 815, the retro-reflector module 712 of the “map” node directs the “map” node to scan its uncertainty region by transmitting a signal toward the “reflect” node. The uncertainty region, as discussed above, is calculated as the arcsine of the nodes' positional error divided by the range. The range is the distance between the nodes. Scanning involves pointing the “map” node's transmit beam toward the retro-reflector installed on the “reflect” node while monitoring or measuring rx, and RSSI. After each measurement, the retro-reflector module 712 of the “map” node directs the “map” node to move its transmit beam by a small amount. The step size can be, for example, between about one one-hundredth of a degree and about three one-hundredths of a degree. The step size can also be about fifty μradians. More generally, the step size can be, for example, about one-tenth of a beam width. This step-wise movement of the “map” node transmitter moves the “map” node transmit beam and the beam reflected from the retro-reflectors mounted on the “reflect” node, which in turn moves the spot incident on the “map” node's receiver by a small amount. After moving the spot at the “map” node, the retro-reflector module 712 directs the “map” node to once again measure the receive power, rx and RSSL By moving the spot and measuring the power levels in a systematic manner, the retro-reflector module 712 causes the “map” node to scan the “map” node's uncertainty region. The retro-reflector module 712 of the “map” node continues to scan until the retro-reflector is found, mapping out areas where no reflection is received. The retro-reflector module 712 determines the nominal location of the retro-reflector by maximizing the receive signal power. This can be done by mapping the reflect area, if necessary.

In a step 820, when the absolute receive power level exceeds about 30,000 μW, the retro-reflector module 712 of the “map” node switches off the “map” node's laser by generating a control signal and sending it to laser driver, or the laser diode source. This provides a check that the “map” node is detecting its own signal. This retro-reflector module 712 can continue this process until the peak signal reflected back to the “map” node's receiver is found. In another variation, the retro-reflector module 712 can use the first reflected signal to attempt to link to the “reflect” node.

In a step 825, the retro-reflector module 712 of the “map” node directs the “map” node to offset its transmit beam to illuminate the “reflect” node's receiver. The offset amount can be provided by the NMA, and is calculated as the distance between the retro-reflector mounted on the “reflect” node and the “reflect” node's receiver. Once the retro-reflector module 712 of the “map” node moves the “map” node's transmit beam to illuminate the “reflect” node's receiver, the “map” node begins to transmit identifying information on the management circuit.

In a step 830, the retro-reflector module 712 in the “reflect” node directs the “reflect” node to scan its uncertainty region with its receive aperture until it detects the signal being transmitted by the “map” node. As above, this is done by moving the receiver by a small amount, then measuring the received power and then moving the receiver again. The retro-reflector module 712 directs these iterative movements across the uncertainty region until the entire region has been viewed. The receive measurements of rx and RSSI may be mapped by the retro-reflector module 712. Once the uncertainty region is mapped, the retro-reflector module 712 determines the desired receiver pointing angle. The desired angle may be calculated by the module 712 as the angle corresponding to the maximum receive power strength, corresponding to the maximum SNR, or by other metrics, such as an orientation that is mid-way between the edges of the received signal. The edges can be defined in various ways. For example, the edge of the received signal can be defined as the point where the received signal strength is reduced by more than twenty to thirty percent. After this step, the transmit beam of the “map” node is already somewhere in the “reflect” node's receive aperture. In the subsequent steps the uncertainty region can be limited to the “reflect” node's receive aperture.

In a step 835, the retro-reflector module 712 in the “reflect” node monitors the rx power reported at the “map” node. The module 712 of the “reflect” node interprets increases in received power at the “map” node receiver as corresponding to improved pointing. As the rx power increases, the retro-reflector module 712 of the “reflect” node slows its scanning. When the retro-reflector module 712 of the “reflect” node gets a link-up report it stops scanning. The link-up report comprises an acknowledgement by the “map” node that it has received the signal being transmitted by the “reflect” node. In the link up report, the “map” node also echoes the orientation information received from the “reflect” node at link up.

At a decision block 840, when the retro-reflector module 712 of the “reflect” node receives the link-up report, it exits the acquisition mode and enters the tracking mode. When the newly installed and adjacent node are unable to acquire, the process shown in FIG. 8 is repeated with larger range and search parameters for the “map” node.

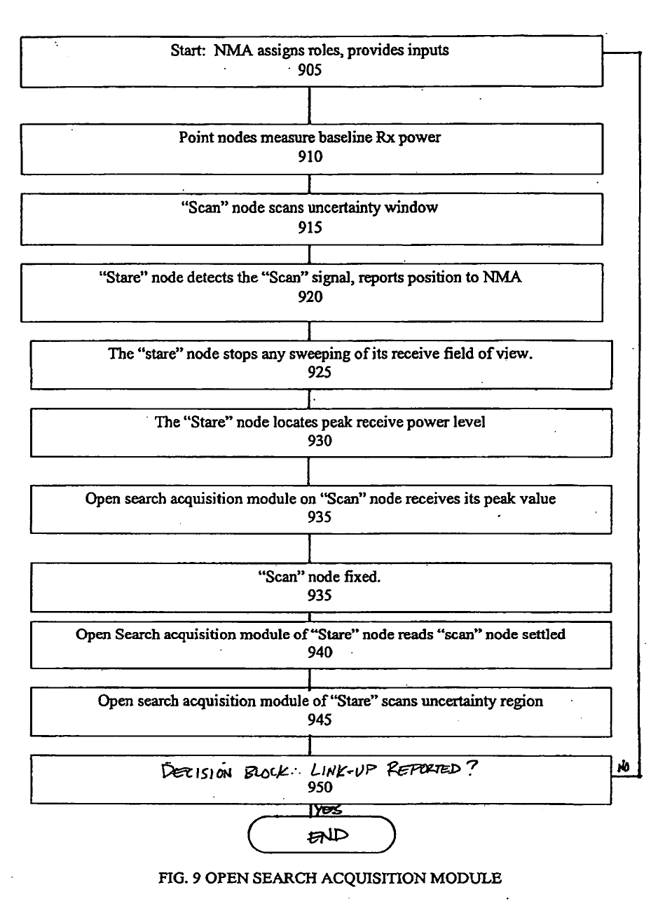

FIG. 9 is a flow chart of a method or process of operation which can be implemented by the open search acquisition module 716. The open search acquisition module 716 can be used when a node is first installed and relies on direct detection by a newly installed node, called the “stare” node, of a signal transmitted by a node already on the network, called the “scan” node. The process implemented by the open search acquisition module 716 is initiated at a start block and step 905. Prior to the start block 905, the module 716 in the “scan” node accepts the “scan” role as assigned by the NMA, while the module 716 in the newly installed node accepts the “stare” role as assigned by the NMA. Also, the NMA provides acquisition, stored state, calibration parameters to the node, and variables related to pointing, including the calculated azimuth and elevation angles, as defined above. In addition, the NMA provides the IP address of the node being installed as well as the NNID of the adjacent node. Also, the NMA provides the range and search parameters to the modules 716 in the “scan” and “stare” nodes.

In a step 910, the open search acquisition module 716 in the “scan” node directs the “scan” node to point to angles calculated by NMA, based on the ephemeris data, and provided to the “scan” node prior to the start block 905 by the NMA. The open search acquisition module 716 in the “stare” node directs the “stare” node to point to angles calculated by NMA, based on ephemeris data, and provided to the “stare” node prior to the start block 905 by the NMA. In the step 905, the open search acquisition modules 716 in both the “scan” and “stare” nodes measure the baseline rx power levels.

In a step 915 the open search acquisition module 716 of the “scan” node directs the “scan” node to scan its uncertainty region. Scanning involves transmitting data packets identifying the “scan” node's pointing angles, or orientation with each step as it scans. The open search acquisition module 716 in the “scan” node also sets the “scan” node power level so as not to overload the “stare” node's receiver.

In a step 920, the “stare” node receiver detects the “scan” signal data packets and the open search acquisition module 716 of the “stare” node records the position of the “scan” node for retrieval by the NMA.

In a step 925, when the open search acquisition module 716 of the “stare” node reports the position of the “scan” node, the open search acquisition module 716 of the “scan” node directs the “scan” node to stop sweeping its field of view.

In a step 930, the open search acquisition module 716 of the “stare” node identifies “scan” node pointing angle associated with the peak power received by the “stare” node's receiver. One way to do this is for the module 716 to direct the “stare” node to step through its receive field of view once for each full scan of its uncertainty region by the “scan” node. If multiple position reports are recorded, the one associated with the largest, receive power level is stored as the database variable value representing the location of the “scan” node. In a step 935, the open search acquisition module of the “scan” node receives data packets from the NMA indicating the largest value of the power level and associated “scan” node location and reports it to the open search acquisition module of the “scan” node.

In a step 935, open search acquisition module 716 of the “scan” node directs the “scan” node to fix the transmitter pointing angle at the values stored in step 930.

In a step 940, the “stare” node detects a “settled” state reported by the “scan” node over the optical interface. The settled state can be detected by the “stare” node as a SNMP “set.”

In a step 945, the “stare” node scans its uncertainty region, which can be limited to the receive aperture. The uncertainty region is scanned until the “scan” node reports signal detection. This can be either through a successful “set” or “get” by the “stare” node.

In a decision block 950, the open search acquisition modules 716 in the “scan” and “stare” nodes either successfully link up and report that link to the NMA, or are unable to link. If the modules 716 of the nodes report a link-up, the tracking module can be activated. If the nodes are unable to link up, steps 905 through 950 are repeated.

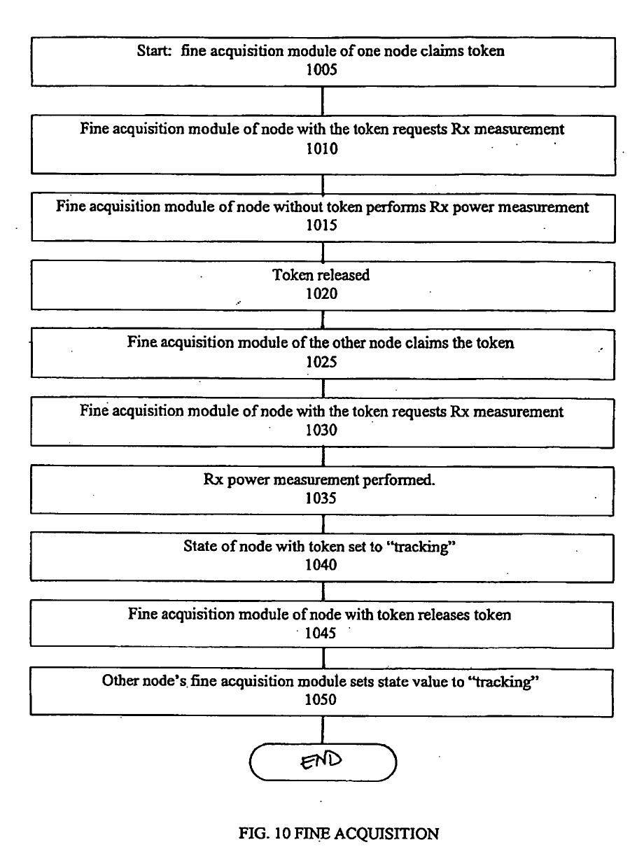

FIG. 10 is a flow chart of a method or process of operation which can be implemented by the fine acquisition module 720. The fine acquisition module 720 is entered when both nodes agree on a state, and is characterized by only one of the two nodes adjusting its pointing angles at a time to improve pointing precision. In a start step 1005, the fine acquisition module 720 in one of the paired node heads 204 claims a token. The token is a marker which determines which node head has permission to request measurements or information from the other node head, and which is used by the controller implementing the fine acquisition protocol. There are various ways to decide which node head will claim the token. For example, the node with the lower media access controller address can claim the token in a step 1005. The media access controller address is a unique identification number, or identifier that enables the nodes to be differentiated from one another.

In a step 1010, the fine acquisition module 720 of the node head which selected the token requests that the node without the token perform a received power (rx) measurement. In a step 1015, the fine acquisition module 720 of the node which does not have the token directs that node to perform the rx measurement requested in step 1010. After step 1015, the fine acquisition module 720 of the node with the token moves the node's transmitter by a very small amount. After the movement that occurs in step 1015, the fine acquisition module 720 in the node with the token directs the node to repeat steps 1010 and 1015 until the maximum power level measured at the receiver of the node without the token is identified, i.e. until the pointing of the node transmitter of the node that selected the token in step 1005 is optimized. Once the pointing of the transmitter of the node which claimed the token in step 1005 is optimized, that node's fine acquisition module 720 releases the token in a step 1020.

In a step 1025, the fine acquisition module 720 of the node which had previously not claimed the token in step 1005 claims the token. Then, in a step 1030, the fine acquisition module 720 of the node with the token requests that the adjacent node measure the rx power. In a step 1035, the node without the token measures the rx power. As discussed above concerning steps 1010-1015, steps 1030-1035 are repeated until the pointing of the node with the token is optimized. Thus, the node with the token moves its transmit optics by a very small amount until the rx power received by the node without the token is maximized, and therefore, the pointing of the transmitter of the node with the token is optimized. Once the pointing is optimized, in a step 1040 the fine acquisition module 720 of the node with the token sets the state value for that node to “tracking.” In a step 1045, the node that claimed the token in step 1035 releases the token. Then, in a step 1050, the state of the node that claimed the token in a step 1005 is set to “tracking.”

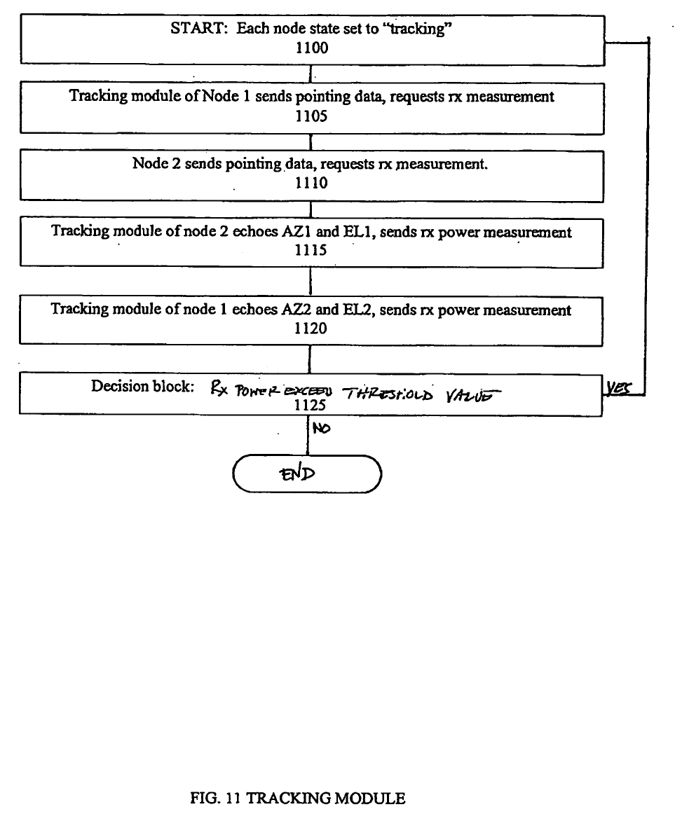

FIG. 11 is a flow chart of a method or process of operation which can be implemented by the tracking module 616. This process can be implemented to maintain an optical link in the presence of small and slow movements of one or more nodes. Such movements can be caused by thermal expansion of the structures on which the nodes are mounted, for example

In a start block 1100, the tracking module 616 of each node sets the node's node state to “tracking.” In a step 1105, the tracking module 616 in one of a pair of nodes (“Node 1”) sends its azimuth pointing angle (AZ1) and elevation pointing angle (EL1) and requests the tracking module 616 of the other node (“Node 2”) to direct that node to perform an rx measurement. In a step 1110, the tracking module 616 of Node 2 directs Node 2 to send its azimuth pointing angle (AZ2) and elevation pointing angle (EL2) to Node 1 and also requests Node 1 to perform an rx measurement. In a step 1115, the tracking module 616 of Node 2 directs Node 2 to echo to Node 1 the received AZ1 and EL1 along with the rx power measurement (rx1) that Node 2 measures. In a step 1120, the tracking module 616 of Node 1 directs Node 1 to echo to Node 2 the received AZ2 and EL2 along with the rx power measurement made by Node 1 (rx2). In a decision block 1125, the tracking modules 616 in Node 1 and Node 2 compare the rx power with a preset threshold value. If the rx power is greater than the threshold value, the tracking modules 616 of Node 1 and Node 2 repeat steps 1105-1125. If the rx power measurement value falls below a preset threshold value, and the tracking module 616 is exited. When the rx power falls below the threshold value, the recovery module 724 may be activated by the controller 422

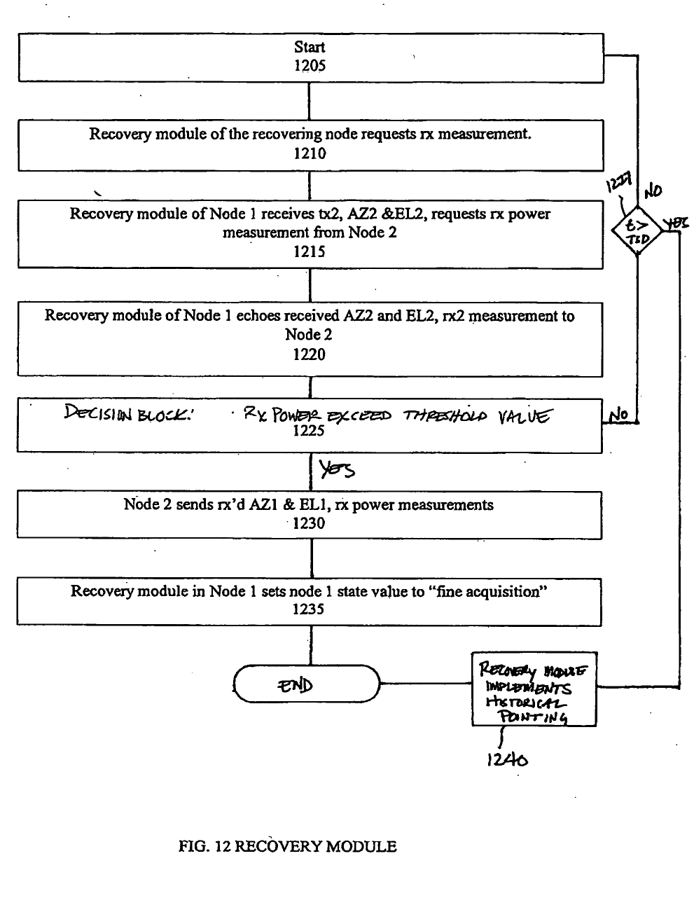

FIG. 12 is a flow chart of a method or process of operation which can be implemented by the recovery module 724. The recovery module 724 is a mechanism for reestablishing an optical link when one has failed, for example, when two paired nodes exit the steps performed by the tracking module 616, as illustrated in FIG. 11.

Prior to start block 1205, the recovering node's state is set to “recovery.” As discussed above, this can occur if its transmit power (tx) is at its maximum power and the paired node of the optical link reports marginal SNR or line of sight (LOS). In a step 1210, the recovery module 724 of the recovering node (Node 1) requests rx power measurement from the other node (Node 2). In a step 1215, the recovery module 724 of Node 1 receives transmit power (tx2), azimuth pointing angle (AZ2), elevation pointing angle (EL2) from Node 2 and requests Node 2 to measure the power received at Node 2 (rx1). In a step 1220 the recovery module 724 of Node 1 echoes the received AZ2 and EL2, and rx1 to Node 2.

In a decision block 1225, the recovery module 724 of Node 1 monitors the rx1 value to see if it exceeds the threshold value. If the rx power threshold value have not been exceeded, the recovery module 724 of the Node 1 directs Node 1 to repeat steps 1205-1225 until the threshold value is exceeded. When the threshold value is exceeded, Node 1's optical link is recovered. In a decision block 1227, the recovery module 724 of Node 1 checks whether a time limit has been exceeded. The time limit can be, for example, about five to ten minutes. If the time limit has been exceeded, the recovery module 724 implements block 1240, which points the nodes at historical angles. These are angles that corresponding to the time of the day and day of the year for paired node heads. These data can correct for thermal expansion, for example, and other cyclical anomalies which can disturb pointing. Historical pointing data are saved in global storage, and when needed are received by the recovery module 724 of each of the nodes from the NMA. Then the recovery module 724 goes to an end block.

If the threshold value is exceeded in the step 1225, the recovery module 724 moves to a step 1230. In the step 1230, Node 2 sends received AZ1 and EL1 along with receive power measured at Node 2 (rx1). In a step 1235, the recovering node's state is set to “fine acquisition.” The recovery module 724 then moves to the end block.

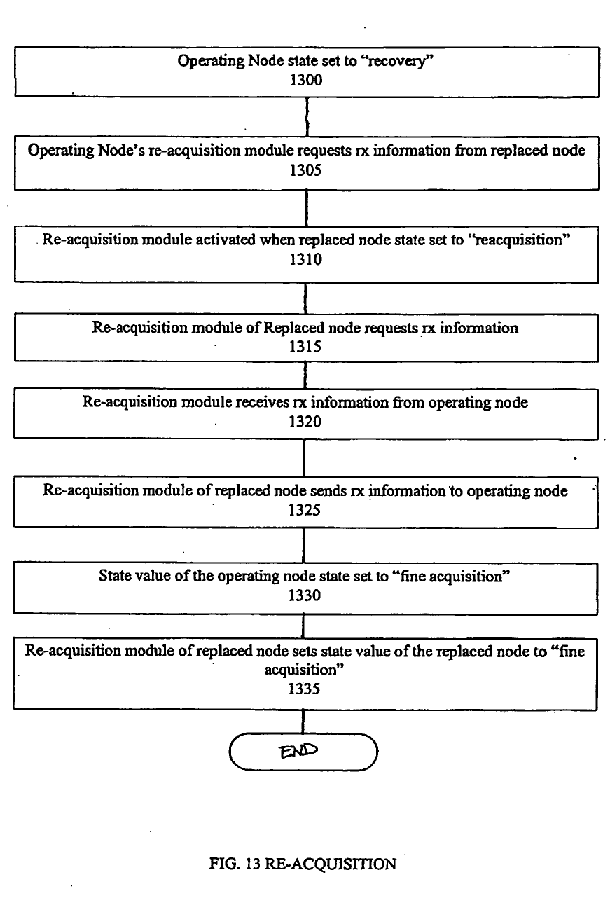

FIG. 13 illustrates a flow chart of a method or process of operation which can be implemented by the re-acquisition module 708. The re-acquisition module can be implemented when a node is replaced or moved. When such a replacement or node movement occurs, the system must re-acquire the new node.

At start block 1300, re-acquisition module 708 of the operating node, i.e. the node not being replace, sets the node state to “recovery.” In a step 1305, the operating node's re-acquisition module 708 requests that the replaced node measure rx power. In a step 1310, the re-acquisition module 708 is activated in the replaced node, and the replaced node's state is set to “re-acquisition.” In a step 1315, the re-acquisition module of the replaced node requests the operating node to perform an rx power measurement. In a step 1320, the re-acquisition module 708 of the operating node sends rx measurements to the replaced node. In a step 1325, the re-acquisition module of the replaced node sends rx measurements to the operating node. In a step 1330, the re-acquisition module of the operating node sets the operating node's state to “fine acquisition.” In a step 1335, the re-acquisition module of the replaced node sets the replaced node's state to “fine acquisition.”

Although the invention has been described in terms of certain examples, other examples that will be apparent to those of ordinary skill in the art, including examples which do not provide all of the features and advantages set forth herein, are also within the scope of this invention. Accordingly, the scope of the invention is defined by the claims that follow.

1. A method for establishing optical links between optical transceiver nodes in a free space optical communications network comprising:
providing a map node having a transmitter and a receiver, the map node having a corresponding uncertainty window;
installing a reflect node;
installing a retro-reflector on the reflect node;
directing the map node to scan the uncertainty window by transmitting a transmit beam until the reflection of the transmit beam is received by the receiver of the map node;
verifying that the signal received by the receiver of the map node is the signal transmitted by the transmitter of the map node;
directing the reflect node to scan its uncertainty space; and
determining whether a link has been achieved.

2. A system for establishing and maintaining optical links between optical transceiver nodes in a free space optical communication network, the system comprising:
a first fixed position node at a first location;
a second fixed position node at a second location including a receiver;
a pointing mechanism mounted on said first fixed position node comprising a transmitter configured to transmit an optical signal, said pointing mechanism configured to automatically adjust both the azimuth and elevation angles of said transmitter so that said transmitter is pointed directly at said receiver and said optical signal is transmitted in a direct path from said transmitter to said receiver; and
a second receiver mounted on said first fixed position node and configured to receive an adjustment signal, said pointing mechanism further configured to automatically adjust said azimuth and elevation angles of said transmitter according to said adjustment signal received by said second receiver.

3. The system of claim 2, further comprising:
a retro reflector mountable on said second fixed position node configured to receive said optical signal transmitted from said transmitter and reflect said optical signal to said second receiver.

4. The system of claim 2, further comprising:
an input/output interface coupled to said first fixed position node and configured to receive said adjustment signal including information regarding the geographic coordinates of said receiver.

5. A node for use in a free space optical communication network, the node comprising:
a pointing mechanism configured to adjust an azimuth angle and an elevation angle;
a first turret having an optical transmitter and an optical receiver and mounted on said pointing mechanism; and
a turret task module comprising
an acquisition module configured to command said pointing mechanism to adjust said azimuth angle and said elevation angle until a response signal from a second remote turret is received, establishing an optical communication link between said first turret and said second remote turret,
a tracking module configured to monitor the strength of said optical communication link between said first turret and said second remote turret, and, in response to said monitoring, command said pointing mechanism to adjust said azimuth angle and said elevation angle in order to improve said optical communication link, and
a transmit power control module configured to monitor a transmit power level of said first turret and, in response to said monitoring, automatically adjust a transmit power level of said first turret.

6. The system of claim 5, wherein said tracking module is further configured to:
determine a first signal strength indicative of a signal transmitted from said optical transmitter of said first turret; and
compare said first signal strength to a threshold value, and, if said first signal strength is less than said threshold value, adjust said azimuth angle and said elevation angle to a historical azimuth angle and a historical elevation angle associated with a last known signal strength that exceeded said threshold value, respectively.

7. The system of claim 5, further comprising:
a recovery module configured to adjust said azimuth angle and said elevation angle of said first turret to a historical azimuth angle and a historical elevation angle associated with a last known signal strength that exceeded said threshold.

8. The system of claim 5, further comprising:
a reacquisition module configured to command said pointing mechanism to automatically adjust said azimuth angle and said elevation angle of said first turret in order to obtain an optical link between said first turret and a replacement turret placed in the same geographic position as said second remote turret.

9. A node for use in a free space optical communication network, the node comprising:
a first node head having a first optical transmitter and a first optical receiver,
a first pointing mechanism configured to adjust a first azimuth angle and a first elevation angle of said first node head;
a second node head having a second optical transmitter and a second optical receiver,
a second pointing mechanism configured to adjust a second azimuth angle and a second elevation angle of said second node head; and
a controller coupled to said first and second node heads and having an acquisition module configured to command said first and second pointing mechanisms to automatically adjust said first and second azimuth angles and said first and second elevation angles until a response signal from a first remote node and a second remote node are received by said first and second node heads, respectively, establishing a first and second optical communication link.

10. The node of claim 9, said node further comprising:
a third node head having a third optical transmitter and a third optical receiver;
a third pointing mechanism configured to adjust a third azimuth angle and a third elevation angle of said third node head; and
said acquisition module is further configured to command said third pointing mechanism to automatically adjust said third azimuth angle and said third elevation angle until a response signal from a third remote node is received, establishing a third optical communication link.

11. The node of claim 10, said node further comprising:
a fourth node head having a fourth optical transmitter and a fourth optical receiver;
a fourth pointing mechanism configured to adjust a fourth azimuth angle and a fourth elevation angle of said fourth node head; and
said acquisition module is further configured to command said fourth pointing mechanism to automatically adjust said fourth azimuth angle and said fourth elevation angle until a response signal from a fourth remote node is received whereby establishing a fourth optical communication link.

12. A method for establishing optical links between optical transceiver nodes in a free space optical communication network including a map node having a pivotably mounted transmitter and receiver, and a reflect node having a mountable retro-reflector, the method comprising:
transmitting a plurality of optical signals from said transmitter of said map node towards said retro-reflector while said transmitter moves through a defined uncertainty range by iteratively adjusting an azimuth angle and an elevation angle of said transmitter;
receiving at said receiver of said map node a plurality of reflected optical signals with a plurality of signal strengths;
determining a maximum signal strength from said plurality of signal strengths;
defining an optimal azimuth angle and an optimal elevation angle as said azimuth angle and said elevation angle of said transmitter associated with said maximum signal strength;
offsetting said optimal azimuth angle and said optimal elevation angle to compensate for the defined distance between said retro reflector and a receiver mounted on said reflect node; and
adjusting said transmitter to said offset optimal azimuth angle and said offset optimal elevation angle so that said transmitter is aligned directly with said receiver mounted on said reflect node.

13. The method of claim 12, further comprising:
aligning said map nod and said reflect node with particularity by commanding said map node to iteratively adjust said azimuth angle and said elevation angle within a defined uncertainty range until a maximum signal strength is received by said reflect node;
adjusting said azimuth angle and said elevation angle to said azimuth angle and said elevation angle associated with said maximum signal strength;
commanding said reflect node to iteratively adjust a second azimuth angle and a second elevation angle of said reflect node within a second defined uncertainty range until a second maximum signal strength is received by said map node; and
adjusting said second azimuth angle and said second elevation angle to said second azimuth angle and said second elevation angle associated with said second maximum signal strength.

14. A method for automatically establishing an optical link between a scan node and a stare node pointed generally towards one another in a free space optical communication network, the method comprising:
transmitting from a rotatably mounted transmitter in said scan node a plurality of signals each including a current azimuth pointing angle of said transmitter, said plurality of signals are transmitted while said transmitter iteratively rotates within a defined uncertainty region such that each of said plurality of signals is transmitted at a different azimuth angle;
receiving at said stare node at least some of said plurality of signals from said transmitter;
determining a plurality of signal strengths associated with said at least some of said plurality of signals received at said stare node;
storing said azimuth pointing angle of said transmitter and an associated signal strength in a network management application (NMA) when each of said at least some of said plurality of signals is received by said stare node, wherein a plurality of azimuth pointing angles and signal strengths are stored in said NMA;
selecting a maximum signal strength from said plurality of signal strengths stored in said NMA;
defining an optimal azimuth pointing angle as said azimuth pointing angle associated with said maximum signal strength; and
moving said transmitter in said scan node to said optimal azimuth pointing angle.

15. The method of claim 14, further including:
transmitting from said scan node a set signal;
transmitting from said stare node a second set signal, wherein when said set signal is received by said stare node and said second set signal is received by said stare node a communication link is established.

16. A method for automatically tracking the movements of optical nodes in a free space optical communication network including first and second nodes aligned generally towards one another, the method comprising:
(a) transmitting from said first node a first signal including a current azimuth pointing angle of said first node, a current elevation angle of said first node, and a request for said second node to measure a first signal strength of said first signal;
(b) receiving at said second node said first signal, wherein said second node measures a first signal strength of said first signal;
(c) transmitting from said second node a second signal including a current azimuth pointing angle of said second node, a current elevation angle of said second node, and a request for said first node to measure a second signal strength of said second signal;
(d) receiving at said first node said second signal, wherein said first node measures a second signal strength of said second signal;
(e) transmitting from said second node a third signal including said first signal strength of said first signal; and
(f) transmitting from said first node a fourth signal including said second signal strength of said second signal, if said first signal strength of said first signal exceeds a first threshold value and said second signal strength of said second signal exceeds a second threshold value said method is repeated from (a).

17. The method of claim 16, further comprising:
iteratively adjusting the current azimuth pointing angle of said first node so that said first signal strength of said first signal exceeds said first threshold value.

18. The method of claim 17, further comprising:
iteratively adjusting the current azimuth pointing angle of said second node so that said second signal strength of said second signal exceeds said second threshold value.
